(19) United States
(12) Patent Application Publication
(10) Pub. No.: US 2018/0131659 A1
(43) Pub. Date: May 10, 2018

(54) Generating Relationship Maps in Online Social Networks

(71) Applicant: Rajesh Narayan, Naperville, IL (US)

(72) Inventor: Rajesh Narayan, Naperville, IL (US)

(21) Appl. No.: 15/344,496

(22) Filed: Nov. 4, 2016

(51) Int. Cl. H04L 12/58; H04L 29/08

(52) U.S. Cl. CPC H04L 51/32; H04L 67/306

(57) ABSTRACT

Disclosed herein are system, method, and computer program product embodiments creating and expanding family maps through an online social-networking system. An embodiment operates by receiving, from a first user of a social-networking system having a first user profile, a first request to add a second user profile to the social-networking system, the first request comprising a name of the second user and a relationship between the first and second users. The social-networking system then creates the second user profile associated with the second user in the social-networking system. The social-networking system then receives, from the first user, profile data associated with the second user and generates a family map display showing the first user and the second user along with the relationship and profile data associated with the second user. An embodiment further operates by receiving a second request to create a new account with ownership of the second profile.

### BACKGROUND

### Technical Field

Embodiments generally relate to social networking through communications networks.

### Background

Social networks allow people to communicate and keep in touch with each other through the use of computing devices connected through communication networks. In general, users of social networks may set up a profile that includes information about themselves, such as name, age, work, interests, etc. Users may create or join social groups with other users, and establish connections with users of their choosing. The social network may allow the users to share information, such as, messages, articles, links, photos, videos, etc. with other social network users. The users may also control who they are connected with, and who can see the information that they post.

### BRIEF DESCRIPTION OF THE DRAWINGS

The accompanying drawings are incorporated herein and form part of the specification.

FIG. 1 is illustrates a social-networking system environment, according to an example embodiment.

FIG. 2 illustrates a graphical user interface for interacting with a social-networking system, according to an example embodiment.

FIG. 3 illustrates a graphical user interface for creating and interacting with a family map within a social-networking system, according to an example embodiment.

FIG. 4 shows a family map interface with functionality to modify a family map, according to an example embodiment.

FIG. 5 shows an interface for adding a new family member to a family map, according to an example embodiment.

FIG. 6 illustrates interactive features of a family map, in an example embodiment.

FIG. 7 is a flowchart for a method for creating and expanding family maps through an online social-networking system, according to an example embodiment.

FIG. 8 is an example computer system useful for implementing various embodiments.

### DETAILED DESCRIPTION

Provided herein are system, method and/or computer program product embodiments, and/or combinations and sub-combinations thereof, for creating and expanding family maps through an online social-networking system.

While the embodiments described herein are exemplified in the context of a social-networking system, they are generally applicable to any system that connects users through an online interface.

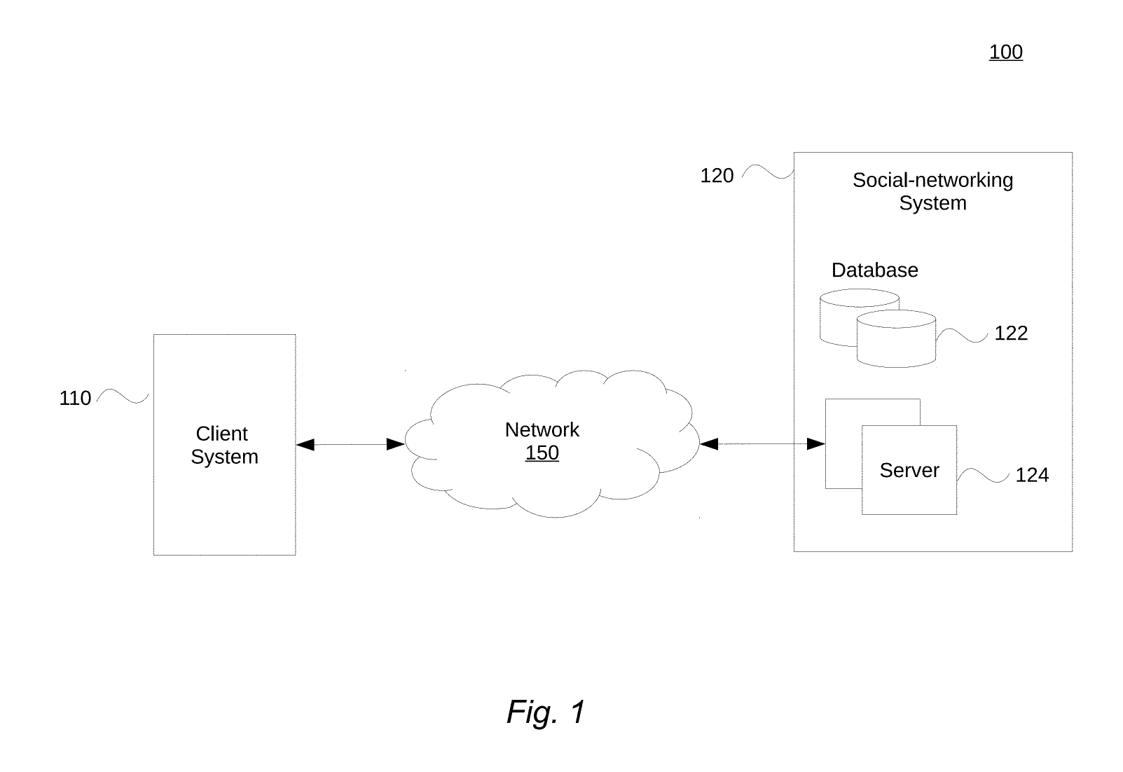

FIG. 1 illustrates a social-networking system environment 100, according to an example embodiment. A client system 110 connects to a social-networking system 120 through a network 150. The network may be any communications network suitable for transmitting data between computing devices, such as, by way of example, a Local Area Network (LAN), a Wide Area Network (WAN), Metropolitan Area Network (MAN), Personal Area Network (PAN), the Internet, wireless networks, satellite networks, overlay networks, or any combination thereof. Client system 110 may be any computing device suitable for interacting with a social-networking system, such as, by way of example, a personal computer, mobile computer, laptop computer, mobile phone, smartphone, personal digital assistant, or tablet computer. Social-networking system 120 may be any computing device or combination of devices suitable to provide social-networking services, such as, by way of example, server computers, database systems, storage area networks, web servers, application servers, or any combination thereof.

A user of client system 110 may interact with social-networking system 120 through any suitable graphical user interface, such as, by way of example, an application, web browser, web application, mobile application, etc. Multiple users of social-networking system 120 may use client systems 110 to establish profiles with social-networking system 120 and establish relationships (e.g., a “friend” or “family” relationship) with other users. Users may publicly or privately share information on the web or with certain other users, such as, by way of example, photos, videos, messages, posts, comments, etc. Each user may configure privacy settings to select what particular information other users or group of users may view.

Social-networking system 120 may maintain information associated with users in one or more databases 122, including by way of example, user account information, user authentication credentials information, user information (e.g., photos, videos, posts, profile information), and privacy settings. Social-networking system 120 may also maintain a social graph storing social connection information of users. As an example, the social graph may comprise a node for each user of the social network, and edges between users that have a “friend” or “family” relationship with each other. Social-networking system 120 may provide social network interface to users through the use of one or more servers 124.

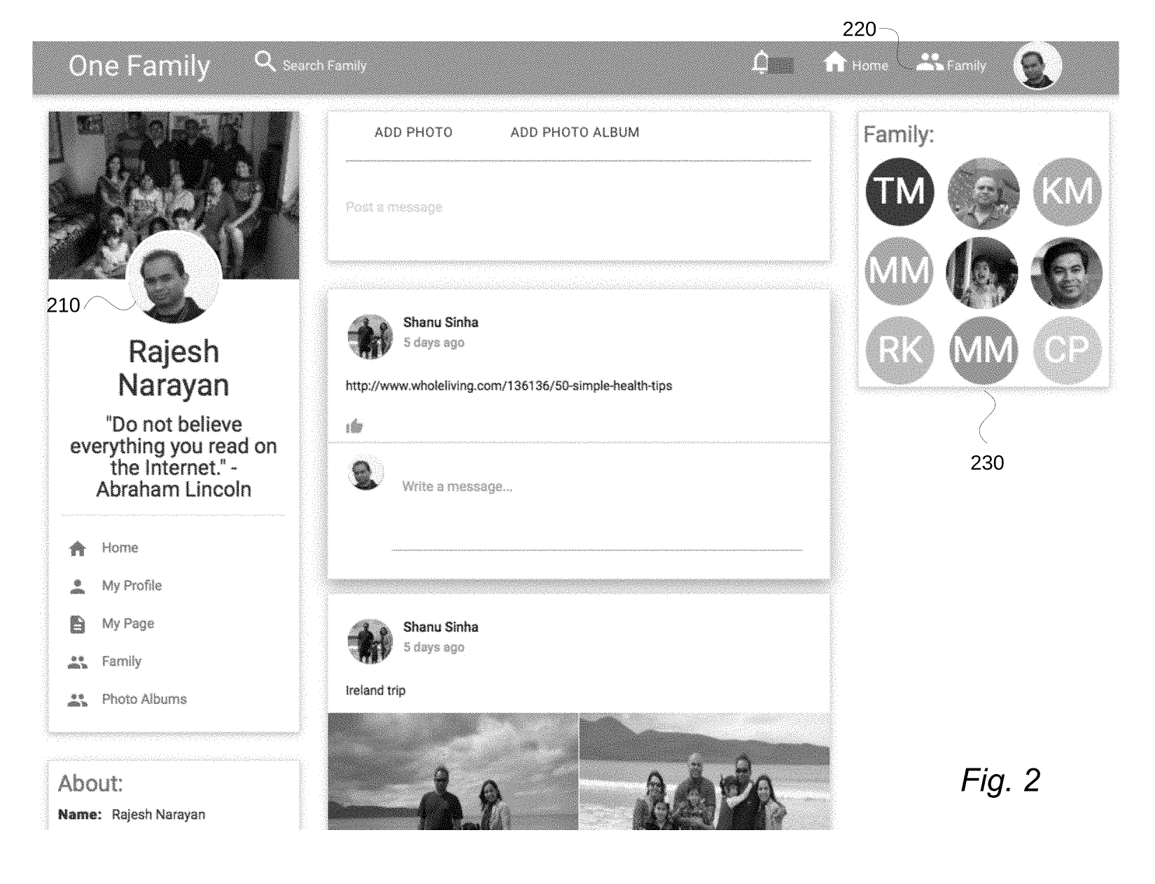

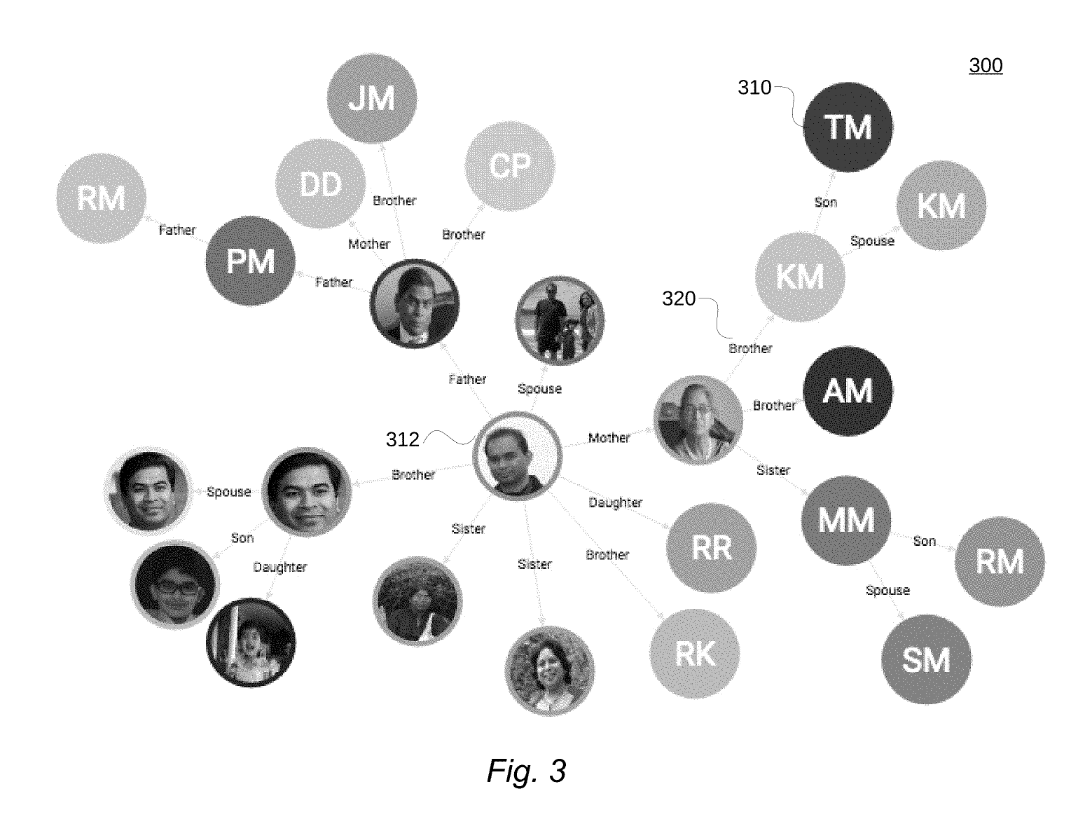

FIG. 2 illustrates a graphical user interface for interacting with social-networking system 120, in an example embodiment. A user may provide and select to display a profile picture 210 associated with the user's profile. Other users may then see the profile picture if they are authorized to do so by the user's privacy settings. A user may view a main board page where the user and other users may submit text posts, photographs, videos, links, post comments, etc. In particular embodiments, the social network interface may include an element 220 to access a Family portion of the social network. In particular embodiments, activating element 220 may redirect a user to an interface 300, as will be described with reference to FIG. 3 below. A user may create a family map describing the user's family. This map may include other users of the social network, as well as other people that are not yet part of the social network. In particular embodiments, the social network interface may display all or a portion of the user's family in the user's profile page, as shown by portion 230 in FIG. 2.

FIG. 3 illustrates a graphical user interface for creating and interacting with a family map within social-networking system 120, according to an example embodiment. The family map interface may include one or more nodes 310, each node representing a family member of the social network user. In particular embodiments, the center node 312 represents the user himself/herself. In particular embodiments, each node may include profile information of the corresponding family members, such as, by way of example, a profile picture or the name or initials of the person. In particular embodiments, each family member is connected to another family member through a relationship edge 320. A relationship edge may represent any family relationship between the users, such as, by way of example, a mother, father, daughter, son, sister, brother, spouse, ex-spouse, step-son, step-daughter, step-brother, or step-sister relationship.

In particular embodiments, a user may modify her family map. As an example, the user may add family members, and in certain instances, remove family members, and modify the profiles of family members. As an example, the user may add a family member that is not currently part of the social network. The user may specify the name and relationship of a family member that she wishes to add to her family map (e.g., “Raj Kumar, brother”). In particular embodiments, when a user adds a family member that is not currently part of the social network, social-networking system 120 creates a profile for the family member, which the user may be able to manage and modify. As an example, the user may upload pictures, assign a profile picture, and enter information (age, location, work, interests, etc.) associated with the new profile of the family member. The user may also permit other users to view the new profile of the family member.

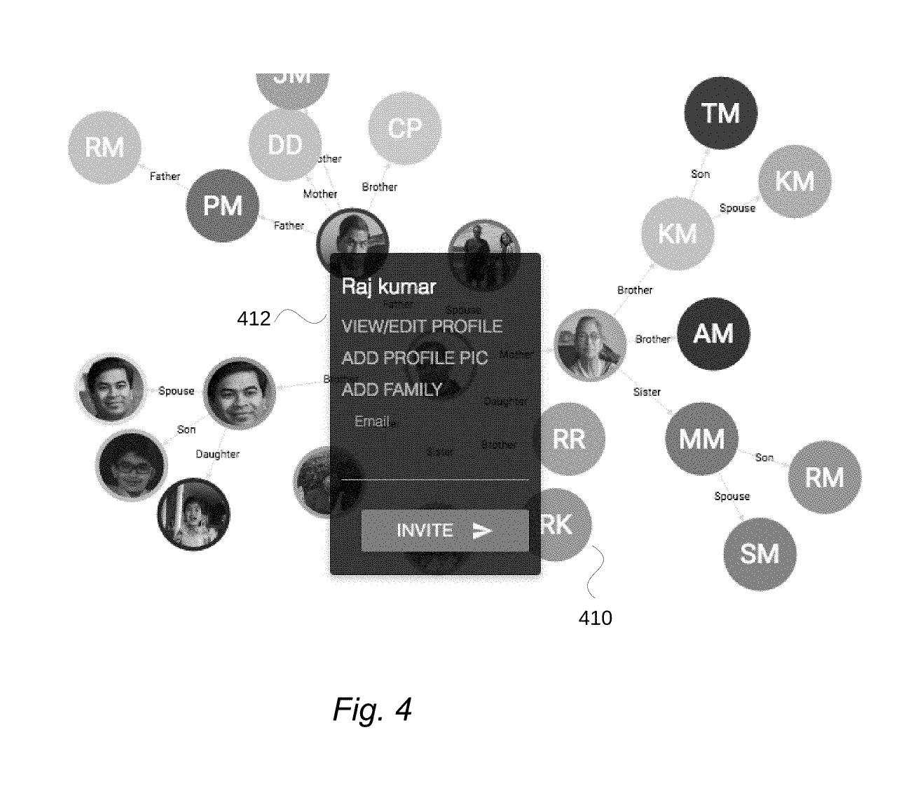

FIG. 4 shows a family map interface with functionality to modify the family map, according to an example embodiment. In the example shown, a user may activate a node associated with a family member in the map to access options (e.g., right-click to display a pop-up menu). In particular embodiments, the user may have the option to invite the family member to join the social network if the family member does not currently have an account with the social network. For example, the user may specify an email address of the family member (e.g., raj.kumar@email.com) when sending out an invitation, and social-networking system 120 may send an email to the family member to invite them to join the social-networking system (e.g., “Your brother Gaurav Kumar has invited you to join OneFamily Social Network. Click here to accept and create your account.”). In particular embodiments, when the family member accepts the invitation and joins the social network, the family member obtains ownership of the profile that the inviting user created, and the social-networking system withdraws access to the inviting user for the profile. In this manner, users may expand their family maps without requiring family members to join the social network, but allowing them to join the social network with the previously created profile.

In particular embodiments, each user views a family map extending from their own person that can affect and be affected by the family maps of other users. As an example, a first user may be connected with her brother in the social network. Her brother may subsequently add his son to the family map. In particular embodiments, the first user would see her brother's son added to her family map as a node connected with a “son” edge to her brother. In particular embodiments, either of the first user or the brother may add additional nodes connected to the first user, to the brother, or to the brother's son. In particular embodiments, if a user adds a new node connected to a family member that has an active account, the family member may be notified for approval of the new member (e.g., “Your brother Gaurav Kumar has added your son Ganesh Kumar to your family map. Click here to confirm this change.”).

In particular embodiments, a user may be able to create new relationships between users of the social network. As an example, a first user may be connected to her brother, who in turn may be connected to his father. If the brother's father is also the first user's father, the first user may establish a direct connection to the father. As an example, the first user may use a click-and-drag operation between her own node and the node of the father to establish a relationship. In particular embodiments, a user may create relationships between any two nodes in her family map. Again, if any of the nodes involved in the relationship have their own account in the social network associated with the node, social-networking system 120 may send them a message to confirm the relationship.

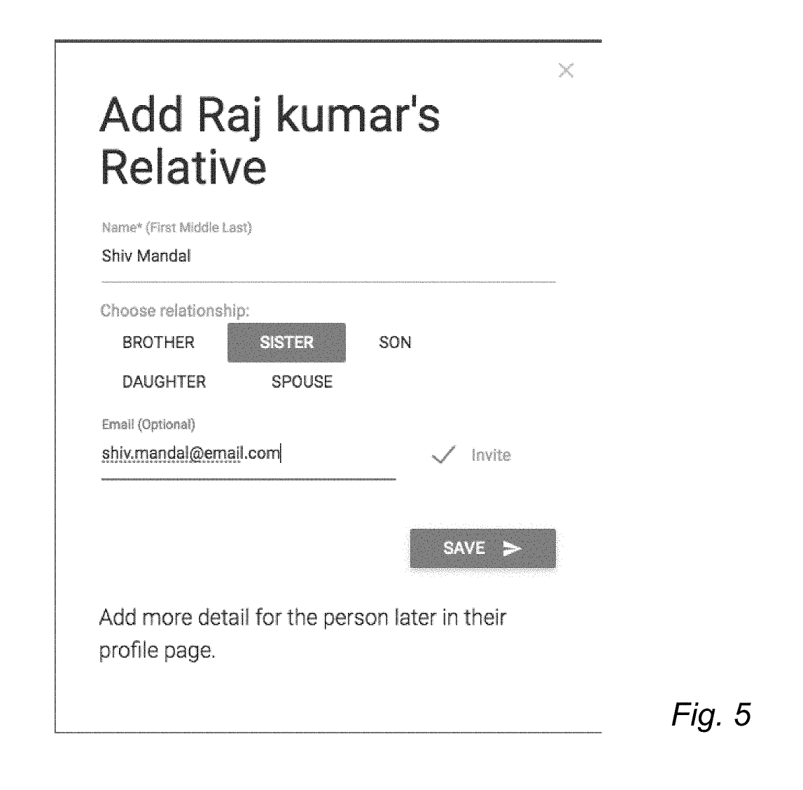

FIG. 5 shows an interface for adding a new family member to the family map, according to an example embodiment. In the example shown, a user may enter the displayed information to add a new relative called Shiv Mandal as a sister to another relative called Raj Kumar. The example also assumes that Shiv Mandal does not have an account with the social network, so the user enters Shiv's email address (“shiv.mandal@email.com”) to send her an invite to join the social network. In particular embodiments, social-networking system 120 may verify that the email address provided is not associated with an existing social network account, and if it is, sends a message verifying the relationship instead of an invite to join the social network. In particular embodiments, social-networking system 120 may determine that a new user of the social network has two or more pre-existing profiles associated with the new user. For example, two distinct family members of the user may have created separate profiles for the new user. When social-networking system 120 detects duplicate profiles, the profiles may be merged into a single profile associated with the new user.

In particular embodiments, social-networking system 120 detects duplicative profiles generated by users. In an embodiment, social-networking system 120 performs data mining of the profile data of users in the system to find two or more profiles that could be associated with the same person. Social-networking system 120 may use any data associated with system users to detect duplicative profiles. As an example, social-networking system 120 may compare names, emails, birthdate, birthplace, hometown, religion, date of death, burial place, other profile data, post history, media history, location, family maps, etc., or any combination thereof, to determine that two profiles may be duplicative. When social-networking system 120 determines two profiles as duplicative, the system may send a notification to the owners of the two profiles notifying each of them that another profile may be of the same person (e.g., “We have found a profile for Gaurav Kumar that may also refer to your great-grandfather Gaurav. Click here to review and verify if these are the same person, and we will consolidate their profiles.”) In an embodiment, if the owners of the corresponding duplicative profiles both confirm that the profiles refer to the same person, social-networking system 120 may consolidate their profiles, for example, by combining their profile data, posts, media, etc.

Additionally, combining duplicative profiles may lead to two or more family maps to be joined through the new consolidated profile. In this manner, users may be able to find family maps of relatives they did not know about before. As an example, a user A may create a profile for her great-great-grandfather C, while a user B creates a profile for her great-uncle D. In an example, social-networking system 120 may detect based on data mining that profiles C and D refer to the same person and, after obtaining confirmation from users A and B, consolidates C and D into a new profile E. In this manner, users A and B would now be connected to each other through profile E. Thus, user A would now have user B in her family map, along with the rest of B's family map. Correspondingly, user B would have user A in her family map, along with the rest of A's family map. In this manner, users A and B may discover each other through a social network, as well as an entire family map that may not have been known before.

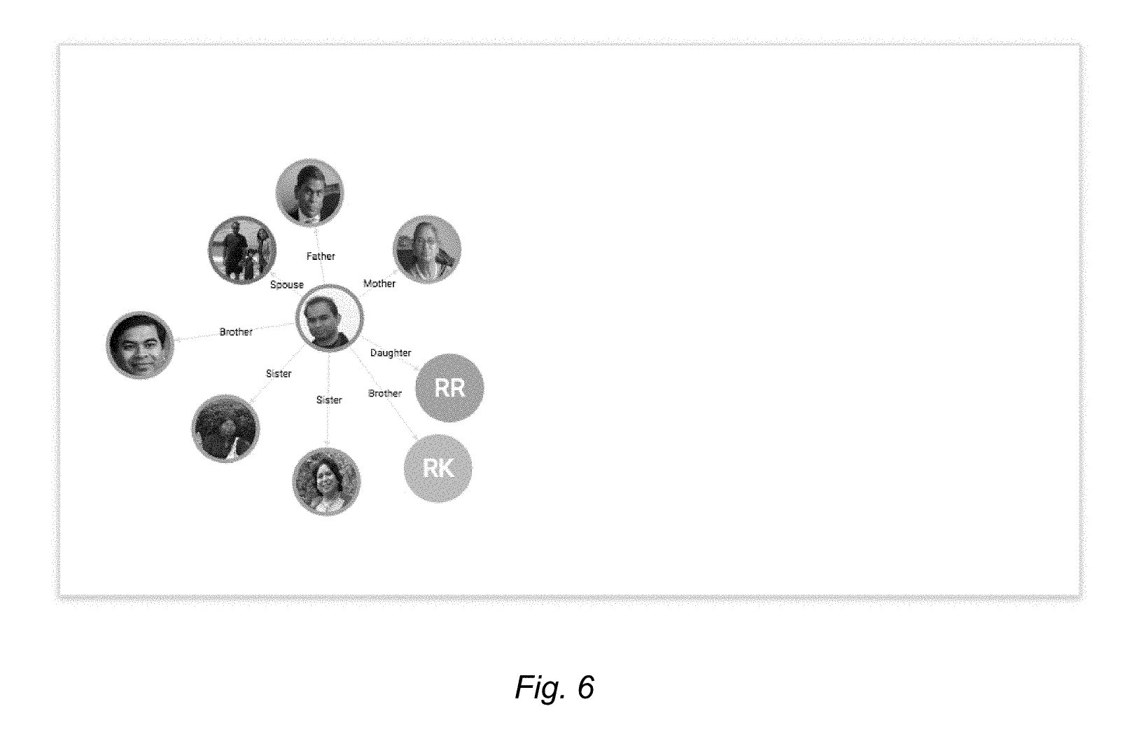

FIG. 6 illustrates interactive features of the family map, in an example embodiment. FIG. 6 shows the same family map of FIGS. 3 and 4, but with second-degree edges collapsed. As an example, a user may click on any node to expand and collapse edges of the nodes to obtain a less cluttered view of the family map. In particular embodiments, the user may also be able to click-and-drag the family map to move it around this screen, for example, in order to view parts of the map that may extend outside of the viewable area of the screen. As an example, the user may move the map by clicking and dragging in any whitespace area of the map.

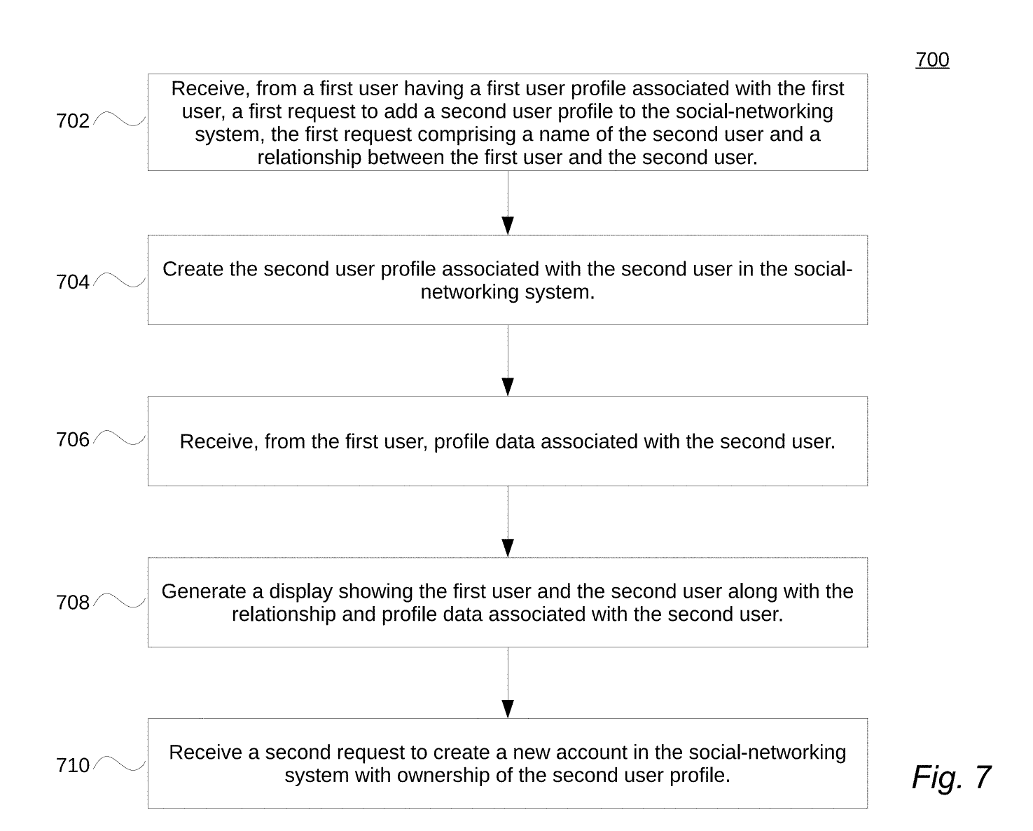

FIG. 7 is a flowchart for a method 700 for creating and expanding family maps through an online social-networking system, according to an example embodiment. Method 300 can be performed by processing logic that can comprise hardware (e.g., circuitry, dedicated logic, programmable logic, microcode, etc.), software (e.g., instructions run on a processing device), or a combination thereof.

In step 702, social-networking system 120 receives, from a first user of the social-networking system, a first request to add a second user to the social-networking system, the first request comprising a name of the second user and a relationship between the first and second users. In step 704, social-networking system 120 creates an account associated with the second user in the social-networking system. In step 706, social-networking system 120 receives, from the first user, profile data associated with the second user. In step 706, social-networking system 120 generates a display showing the first user and the second user along with the relationship and profile data associated with the second user. In step 708, social-networking system 120 receives, from the second user, a second request to obtain ownership of the account associated with the second user.

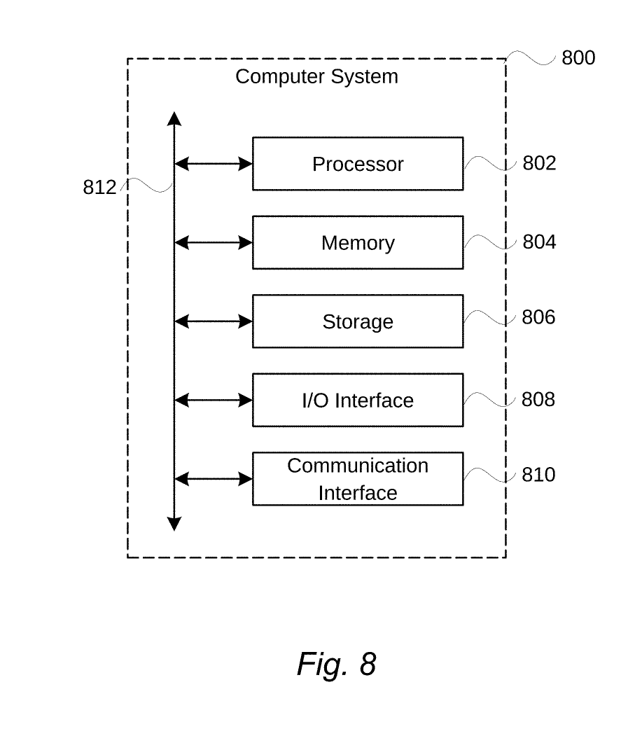

FIG. 8 illustrates an example computer system 800. In particular embodiments, one or more computer systems 800 perform one or more steps of one or more methods described or illustrated herein. In particular embodiments, one or more computer systems 800 provide functionality described or illustrated herein. In particular embodiments, software running on one or more computer systems 800 performs one or more steps of one or more methods described or illustrated herein or provides functionality described or illustrated herein. Particular embodiments include one or more portions of one or more computer systems 800. Herein, reference to a computer system may encompass a computing device, and vice versa, where appropriate. Moreover, reference to a computer system may encompass one or more computer systems, where appropriate.

This disclosure contemplates any suitable number of computer systems 800. This disclosure contemplates computer system 800 taking any suitable physical form. As example, computer system 800 may be an embedded computer system, a desktop computer system, a laptop or notebook computer system, a mainframe, a mobile telephone, a personal digital assistant (PDA), a server, a tablet computer system, or a combination of two or more of these. Where appropriate, computer system 800 may include one or more computer systems 800; be unitary or distributed; span multiple locations; span multiple machines; span multiple data centers; or reside in a cloud, which may include one or more cloud components in one or more networks. Where appropriate, one or more computer systems 800 may perform without substantial spatial or temporal limitation one or more steps of one or more methods described or illustrated herein. As an example, one or more computer systems 800 may perform in real time or in batch mode one or more steps of one or more methods described or illustrated herein. One or more computer systems 800 may perform at different times or at different locations one or more steps of one or more methods described or illustrated herein, where appropriate.

In particular embodiments, computer system 800 includes a processor 802, memory 804, storage 806, an input/output (I/O) interface 808, a communication interface 810, and a bus 812. Although this disclosure describes and illustrates a particular computer system having a particular number of particular components in a particular arrangement, this disclosure contemplates any suitable computer system having any suitable number of any suitable components in any suitable arrangement.

In particular embodiments, processor 802 includes hardware for executing instructions, such as those making up a computer program. As an example, to execute instructions, processor 802 may retrieve (or fetch) the instructions from an internal register, an internal cache, memory 804, or storage 806; decode and execute them; and then write one or more results to an internal register, an internal cache, memory 804, or storage 806. In particular embodiments, processor 802 may include one or more internal caches for data, instructions, or addresses. This disclosure contemplates processor 802 including any suitable number of any suitable internal caches, where appropriate. In particular embodiments, processor 802 may include one or more internal registers for data, instructions, or addresses. This disclosure contemplates processor 802 including any suitable number of any suitable internal registers, where appropriate. Where appropriate, processor 802 may include one or more arithmetic logic units (ALUs); be a multi-core processor; or include one or more processors 802. Although this disclosure describes and illustrates a particular processor, this disclosure contemplates any suitable processor.

In particular embodiments, memory 804 includes main memory for storing instructions for processor 802 to execute or data for processor 802 to operate on. As an example, computer system 800 may load instructions from storage 806 or another source (such as, for example, another computer system 800) to memory 804. Processor 802 may then load the instructions from memory 804 to an internal register or internal cache. To execute the instructions, processor 802 may retrieve the instructions from the internal register or internal cache and decode them. During or after execution of the instructions, processor 802 may write one or more results (which may be intermediate or final results) to the internal register or internal cache. Processor 802 may then write one or more of those results to memory 804. In particular embodiments, processor 802 executes only instructions in one or more internal registers or internal caches or in memory 804 (as opposed to storage 806 or elsewhere) and operates only on data in one or more internal registers or internal caches or in memory 804 (as opposed to storage 806 or elsewhere). One or more memory buses (which may each include an address bus and a data bus) may couple processor 802 to memory 804. Bus 812 may include one or more memory buses, as described below. In particular embodiments, memory 804 includes random access memory (RAM). This RAM may be volatile memory, where appropriate Memory 804 may include one or more memories 804, where appropriate. Although this disclosure describes and illustrates particular memory, this disclosure contemplates any suitable memory.

In particular embodiments, storage 806 includes mass storage for data or instructions. As an example, storage 806 may include a hard disk drive (HDD), a floppy disk drive, flash memory, an optical disc, a magneto-optical disc, magnetic tape, or a Universal Serial Bus (USB) drive or a combination of two or more of these. Storage 806 may include removable or non-removable (or fixed) media, where appropriate. Storage 806 may be internal or external to computer system 800, where appropriate. In particular embodiments, storage 806 is non-volatile, solid-state memory. In particular embodiments, storage 806 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 806 taking any suitable physical form. Storage 806 may include one or more storage control units facilitating communication between processor 802 and storage 806, where appropriate. Where appropriate, storage 806 may include one or more storages 806. Although this disclosure describes and illustrates particular storage, this disclosure contemplates any suitable storage.

In particular embodiments, I/O interface 808 includes hardware, software, or both, providing one or more interfaces for communication between computer system 800 and one or more I/O devices. Computer system 800 may include one or more of these I/O devices, where appropriate. One or more of these I/O devices may enable communication between a person and computer system 800. As an example, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 808 for them. Where appropriate, I/O interface 808 may include one or more device or software drivers enabling processor 802 to drive one or more of these I/O devices. I/O interface 808 may include one or more I/O interfaces 808, where appropriate. Although this disclosure describes and illustrates a particular I/O interface, this disclosure contemplates any suitable I/O interface.

In particular embodiments, communication interface 810 includes hardware, software, or both providing one or more interfaces for communication (such as, for example, packet-based communication) between computer system 800 and one or more other computer systems 800 or one or more networks. As an example, communication interface 810 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 810 for it. As an example, computer system 800 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 800 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 800 may include any suitable communication interface 810 for any of these networks, where appropriate. Communication interface 810 may include one or more communication interfaces 810, where appropriate. Although this disclosure describes and illustrates a particular communication interface, this disclosure contemplates any suitable communication interface.

In particular embodiments, bus 812 includes hardware, software, or both coupling components of computer system 800 to each other. As an example, bus 812 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 812 may include one or more buses 812, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

It is to be appreciated that the Detailed Description section, and not the Summary and Abstract sections (if any), is intended to be used to interpret the claims. The Summary and Abstract sections (if any) may set forth one or more but not all exemplary embodiments of the invention as contemplated by the inventor(s), and thus, are not intended to limit the invention or the appended claims in any way.

While the invention has been described herein with reference to exemplary embodiments for exemplary fields and applications, it should be understood that the invention is not limited thereto. Other embodiments and modifications thereto are possible, and are within the scope and spirit of the invention. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments may perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein.

The breadth and scope of the invention should not be limited by any of the above-described exemplary embodiments, but should be defined only in accordance with the following claims and their equivalents.

What is claimed is:

1. A computer implemented method comprising, by at least one processor:
receiving, from a first user of a social-networking system having a first user profile associated with the first user, a first request to add a second user profile to the social-networking system, the first request comprising a name of a second user and a relationship between the first user and the second user;
creating the second user profile associated with the second user in the social-networking system;
receiving, from the first user, profile data associated with the second user;
generating a display showing the first user and the second user along with the relationship and profile data associated with the second user; and
receiving a second request to create a new account in the social-networking system with ownership of the second user profile.

2. The method of claim 1, wherein the relationship comprises a mother, father, daughter, son, sister, brother, spouse, ex-spouse, step-son, step-daughter, step-brother, or step-sister relationship.

3. The method of claim 1, further comprising:
receiving, from the first user, an invite request to invite the second user to join the social-networking system;
transmitting, to the second user, an invitation to join the social-networking system, wherein the second request to create the new account with ownership of the second user profile associated comprises a response to the invitation.

4. The method of claim 3, further comprising:
removing access to the second user profile from the first user in response to the receiving the second request to create the new account with ownership of the second profile.

5. The method of claim 1, wherein the display comprises an interactive visual graph showing nodes connected by edges, the nodes comprising profile data of the first user and profile data of one or more other users related to the first user.

6. The method of claim 5, wherein the profile data comprises one or more profile pictures associated with the first user and the one or more other users, and the edges describe one or more relationships between any of the one or more other users and between the first user and any of the one or more users.

7. The method of claim 3, further comprising:
receiving, from the first user, a fourth request to create a relationship between the first user and a third user;
transmitting, to the third user, a request for confirmation of the relationship between the first user and the third user; and
upon receipt of the confirmation, creating a relationship edge between the first user and the third user.

8. The method of claim 1, further comprising:
determining a likelihood that a third profile and a fourth profile are associated with a same person;
based on the likelihood, transmitting a notification to an owner of the third profile to confirm that the fourth profile is associated with the person;
based on the likelihood, transmitting a notification to an owner of the fourth profile to confirm that the third profile is associated with the person; and
upon receiving confirmations from the owner of the third profile and the owner of the fourth profile, consolidating the third and fourth profiles into a fifth profile.

9. A system, comprising:
a memory; and
at least one processor coupled to the memory and configured to:
receive, from a first user of a social-networking system having a first user profile associated with the first user, a first request to add a second user profile to the social-networking system, the first request comprising a name of a second user and a relationship between the first user and the second user;
create the second profile associated with the second user in the social-networking system;
receive, from the first user, profile data associated with the second user;
generate a display showing the first user and the second user along with the relationship and profile data associated with the second user; and
receive a second request to create a new account in the social-networking system with ownership of the second user profile.

10. The system of claim 9, wherein the relationship comprises a mother, father, daughter, son, sister, brother, spouse, ex-spouse, step-son, step-daughter, step-brother, or step-sister relationship.

11. The system of claim 9, the at least one processor further configured to:
receive, from the first user, an invite request to invite the second user to join the social-networking system;
transmit, to the second user, an invitation to join the social-networking system, wherein the second request to create the new account with ownership of the second user profile comprises a response to the invitation.

12. The system of claim 11, the at least one processor further configured to:
remove access to the second user profile from the first user in response to the receiving, from the second user, the second request to create the new account with ownership of the profile.

13. The system of claim 9, wherein the display comprises an interactive visual graph showing nodes connected by edges, the nodes comprising profile data of the first user and profile data of one or more other users related to the first user.

14. The system of claim 13, wherein the profile data comprises one or more profile pictures associated with the first user and the one or more other users, and the edges describe one or more relationships between any of the one or more other users and between the first user and any of the one or more users.

15. The system of claim 11, the at least one processor further configured to:
receive, from the first user, a fourth request to create a relationship between the first user and a third user;
transmit, to the third user, a request for confirmation of the relationship between the first user and the third user; and
upon receipt of the confirmation, create a relationship edge between the first user and the third user.

16. The system of claim 9, the at least one processor further configured to:
determine a likelihood that a third profile and a fourth profile are associated with a same person;
based on the likelihood, transmit a notification to an owner of the third profile to confirm that the fourth profile is associated with the person;
based on the likelihood, transmit a notification to an owner of the fourth profile to confirm that the third profile is associated with the person; and
upon receiving confirmations from the owner of the third profile and the owner of the fourth profile, consolidate the third and fourth profiles into a fifth profile.

17. A non-transitory computer-readable medium having instructions stored thereon that, when executed by at least one computing device, causes the at least one computing device to perform operations comprising:
receiving, from a first user of a social-networking system having a first user profile associated with the first user, a first request to add a second user profile to the social-networking system, the first request comprising a name of a second user and a relationship between the first user and the second user;
creating the second user profile associated with the second user in the social-networking system;
receiving, from the first user, profile data associated with the second user;
generating a display showing the first user and the second user along with the relationship and profile data associated with the second user; and
receiving a second request to create a new account in the social-networking system with ownership of the second user profile.

18. The computer-readable medium of claim 17, wherein the relationship comprises a mother, father, daughter, son, sister, brother, spouse, ex-spouse, step-son, step-daughter, step-brother, or step-sister relationship.

19. The computer-readable medium of claim 17, the operations further comprising:
receiving, from the first user, an invite request to invite the second user to join the social-networking system;
transmitting, to the second user, an invitation to join the social-networking system, wherein the second request to create the new account with ownership of the second user profile comprises a response to the invitation.

20. The computer-readable medium of claim 19, the operations further comprising:
removing access to the second profile from the first user in response to the receiving, from the second user, the second request to create the new account with ownership of the profile.

21. The computer-readable medium of claim 17, wherein the display comprises an interactive visual graph showing nodes connected by edges, the nodes comprising profile data of the first user and profile data of one or more other users related to the first user.

22. The computer-readable medium of claim 21, wherein the profile data comprises one or more profile pictures associated with the first user and the one or more other users, and the edges describe one or more relationships between any of the one or more other users and between the first user and any of the one or more users.

23. The computer-readable medium of claim 17, the operations further comprising:
determining a likelihood that a third profile and a fourth profile are associated with a same person;
based on the likelihood, transmitting a notification to an owner of the third profile to confirm that the fourth profile is associated with the person;
based on the likelihood, transmitting a notification to an owner of the fourth profile to confirm that the third profile is associated with the person; and
upon receiving confirmations from the owner of the third profile and the owner of the fourth profile, consolidating the third and fourth profiles into a fifth profile
